(19) United States
(12) Patent Application Publication
(10) Pub. No.: US 2011/0157518 A1
(43) Pub. Date: Jun. 30, 2011

(54) LIGHT SHAPING FILM AND LIQUID CRYSTAL DISPLAY DEVICE INCLUDING THE SAME

(76) Inventor: Jung-Hyun Ham, Gyeonggi-do (KR)

(21) Appl. No.: 12/968,611

(22) Filed: Dec. 15, 2010

(30) Foreign Application Priority Data
Dec. 29, 2009 (KR) 10-2009-0133068

(51) Int. Cl. G02F 1/13357; G02B 5/02

(52) U.S. Cl. 349/64; 359/599

(57) ABSTRACT

A liquid crystal display device includes a liquid crystal panel; and a backlight unit providing a light to the liquid crystal panel, the backlight unit including: a light source under the liquid crystal panel; and first and second light shaping films between the light source and the liquid crystal panel, the first light shaping films including a first base layer and a plurality of first prism patterns, and the second light shaping films including a second base layer and a plurality of second prism patterns, wherein each of the first and second base layers has a haze, and the plurality of first prism patterns cross the plurality of second prism patterns.

The present application claims the benefit of Korean Patent Application No. 10-2009-0133068 filed in Korea on Dec. 29, 2009, which is hereby incorporated by reference.

### BACKGROUND OF THE INVENTION

1. Field of the Invention

The present invention relates to a liquid crystal display device and more particularly to a light shaping film being capable of improving efficiency of a modulation process of a liquid crystal display (LCD) device and the LCD device including the light shaping film.

2. Discussion of the Related Art

As the society has entered in earnest upon an information age, flat panel display devices, such as an LCD device, a plasma display panel (PDP), an electroluminescence display (EL) device, and a field emission display (FED) device, which have excellent capabilities of a thin profile, light weight and low power consumption, and so on, are introduced.

Among these devices, an active matrix type liquid crystal display (LCD) device is widely used for notebook computers, monitors, TV, and so on instead of a cathode ray tube (CRT), because of their high contrast ratio and characteristics adequate to display moving images.

Since the LCD device does not include a light source therein, an additional light source is required. For example, a backlight unit including a lamp is disposed under a liquid crystal panel to provide light onto the liquid crystal panel. The LCD device can display images using the light from the backlight unit.

Generally, the backlight unit is classified into a side type and a direct type depending on a position of the light source. In the side type backlight unit, the light source is positioned at a side of the backlight unit. The light from the light source in the side type backlight unit is refracted by a light guide plate to proceed to the liquid crystal panel. On the other hand, in the direct type backlight unit, the light source is positioned at a center of the backlight unit such that the light from the light source is directly provided to the liquid crystal panel.

FIG. 1 is an exploded perspective view of a side type backlight unit according to the related art.

As shown in FIG. 1, a backlight unit 20 includes a lamp 29a as a light source, a lamp guide 29b for guiding the lamp 29a, a reflective sheet 25, a light guide plate 23 and an optical sheet 21. The reflective sheet 25 is disposed under the light guide plate 23. A side of the light guide plate 23 faces the lamp 29a, and the optical sheet 21 is disposed on the light guide plate 23.

The optical sheet 23 includes a diffusion sheet 21a, a light-concentration sheet 21b and a protection sheet 21c for protecting a prism of the light-concentration sheet 21b. The optical sheet 23 includes one light-concentration sheet 21b. Alternatively, the optical sheet 23 may include at least two light-concentration sheets 21b for high brightness.

As mentioned above, since the backlight unit 20 has many elements, processing time for modulation of the LCD device is increased and processing yield for modulation of the LCD device is decreased. As a result, production cost is increased. In addition, although there is high requirement for slim and light weight LCD device, there are limitations because of the backlight unit 20.

### SUMMARY OF THE INVENTION

Accordingly, the present invention is directed to a light shaping film and an LCD device including the light shaping film that substantially obviate one or more of the problems due to limitations and disadvantages of the related art.

An object of the present invention is to decrease modulation process time and production cost of an LCD device.

Another object of the present invention is to increase light efficiency of a backlight unit and produce an image having uniform brightness.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, a. liquid crystal display device includes a liquid crystal panel; and a backlight unit providing a light to the liquid crystal panel, the backlight unit including: a light source under the liquid crystal panel; and first and second light shaping films between the light source and the liquid crystal panel, the first light shaping films including a first base layer and a plurality of first prism patterns, and the second light shaping films including a second base layer and a plurality of second prism patterns, wherein each of the first and second base layers has a haze, and the plurality of first prism patterns cross the plurality of second prism patterns.

In another aspect, a light shaping film for a backlight unit of a liquid crystal panel includes a first film including a first base layer and a plurality of first prism patterns; and a second film including a second base layer and a plurality of second prism patterns, wherein each of the first and second base layers has a haze, and the plurality of first prism patterns cross the plurality of second prism patterns.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic exploded perspective view of a side type backlight unit according to the related art;

FIG. 2 is a schematic exploded perspective view of an LCD device according to the present invention;

FIG. 3 is a schematic exploded perspective view of a backlight unit in FIG. 2; and

FIG. 4 is a schematic cross-sectional view of a light shaping film of a backlight unit for an LCD device according to the present invention.

### DETAILED DESCRIPTION OF THE PREFERRED EMBODIMENTS

Reference will now be made in detail to the preferred embodiments, examples of which are illustrated in the accompanying drawings.

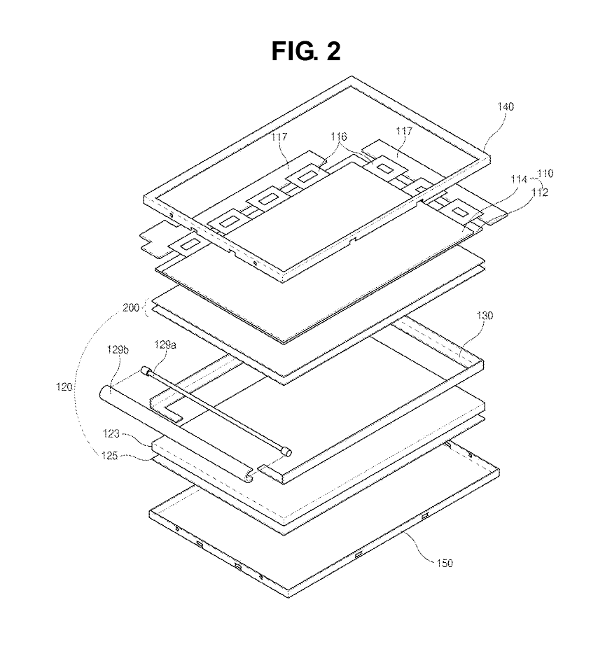

FIG. 2 is a schematic exploded perspective view of an LCD device according to the present invention. In FIG. 2, an LCD device includes a liquid crystal panel 110, a backlight unit 120, a main frame 130, a top frame 140 and a bottom frame 150.

The liquid crystal panel 110 includes a first substrate 112, a second substrate 114 and a liquid crystal layer (not shown). The first and second substrates 112 and 114 face each other, and the liquid crystal layer is interposed therebetween. Assuming the liquid crystal panel 110 is driven by an active matrix type, a gate line (not shown) and a data line (not shown) are formed on the first substrate 112. The gate and data lines cross each other to define a pixel. A thin film transistor (TFT) (not shown) is also formed on the first substrate 112 and positioned at a crossing portion of the gate and data lines. In addition, a pixel electrode (not shown) is positioned in each pixel and connected to the pixel electrode. The first substrate 112 may be called as an array substrate. On the other hand, red, green and blue color filters (not shown) are formed on the second substrate 114. In addition, a black matrix (not shown) for shielding the gate and data lines and the TFT and a common electrode for generating an electric field with the pixel electrode are formed on the second substrate 114. The second substrate 114 may be called as a color filter substrate.

A polarizing plate (not shown) for selectively transmitting light is formed on an outer surface of each of the first and second substrates 112 and 114. An alignment layer (not shown) for an initial arrangement of liquid crystal molecules of the liquid crystal layer is formed between the first substrate 112 and the liquid crystal layer and between the second substrate 114 and the liquid crystal layer. In addition, a seal pattern for sealing the liquid crystal layer is formed at edges of the first and second substrates 112 and 114.

A printed circuit board (PCB) 117 is connected to one side of the liquid crystal panel 110 via a connection member 116, for example, a tape carrier package. The PCB 117 is bent along a side surface of the main frame 130 or a rear surface of the bottom frame 150 during a modulation process of the LCD device.

When the TFT is turned on by a signal, which is applied to the TFT through the gate line and generated from a gate driving circuit, a signal voltage from a data driving circuit is supplied to the pixel electrode through the data line. An arrangement of liquid crystal molecules are controlled by an electric field induced between the pixel and common electrode to change transmittance.

The backlight unit 120 is disposed under the liquid crystal panel 110 such that light is provided onto the liquid crystal panel 110. The backlight unit 120 includes a lamp 129a as a light source, a reflective sheet 125, a light guide plate 123 and a light shaping films 200 on the light guide plate 123.

The lamp 129a is disposed at one side of the light guide plate 123. The backlight unit 120 further includes a lamp guide 129b for guiding the lamp 129a. The reflective sheet 125 is disposed under the light guide plate 123 and has a color of white or silver. The light guide plate 123 is disposed on the reflective sheet 125. Light from the lamp 129a travels the light guide plate 123. As a result, a plane light source is provided onto the liquid crystal panel 110 by a total reflection in the light guide plate 123. The light through a rear surface of the light guide plate 123 is reflected on the reflective sheet 125 toward the liquid crystal panel 110 such that brightness is increased.

The light through the light guide plate 123 is diffused and concentrated by the light shaping film 200 on the light guide plate 123 such that an uniform plate light source is provided on the liquid crystal panel 110.

The liquid crystal panel 110 and the backlight unit 120 are modulated with the main frame 130, the top frame 140 and the bottom frame 150. The top frame 140 covers edges of a front surface of the liquid crystal panel 110 and side surfaces of the liquid crystal panel 110. The top frame 140 has an opening such that images from the liquid crystal panel 110 can be displayed through the opening of the top frame 140. The main frame 130 has a rectangular frame shape. The main frame 130 covers side surfaces of the liquid crystal panel 110 and the backlight unit 120 and is combined with the top frame 140 and the bottom frame 150. The bottom frame 150 includes a bottom surface and four side surfaces to cover a rear surface of the backlight unit 120 and side surfaces of the backlight unit 120. The bottom frame 150 covers a rear side of the backlight unit 120. The above backlight unit 120 may be called as a side light type. Namely, the lamp 124 is arranged along one side of the main frame 130. The lamp 124 may be further arranged along an opposite side of the main frame 130.

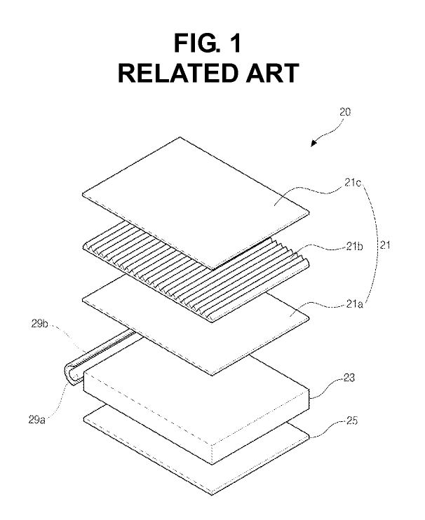

The LCD device has a thickness smaller than the related art LCD device because the backlight unit has a reduced thickness. The optical sheet 21 (of FIG. 1) of the backlight unit for the related art LCD device requires at least one diffusion sheet 21a (of FIG. 1), one light-concentration sheet 21b (of FIG. 1) and one protection sheet 21c (of FIG. 1). In addition, to obtain high brightness, at least two light-concentration sheets are required. However, the backlight unit 120 requires the light shaping film 200, which includes first and second light shaping films 210 and 220 (of FIG. 3), without the optical sheet 21 (of FIG. 1) such that a thickness of the backlight unit 120 is reduced.

As a result, the LCD device according to the present invention has light weight and slimness. In addition, since there are smaller number elements in the backlight unit according to the present invention than the backlight unit according to the related art, there are advantages of process time and processing yield in modulation of the LCD device. In addition, since two light shaping films 210 and 220 replace at least three sheets of the optical sheet 21 (of FIG. 1), production cost is reduced.

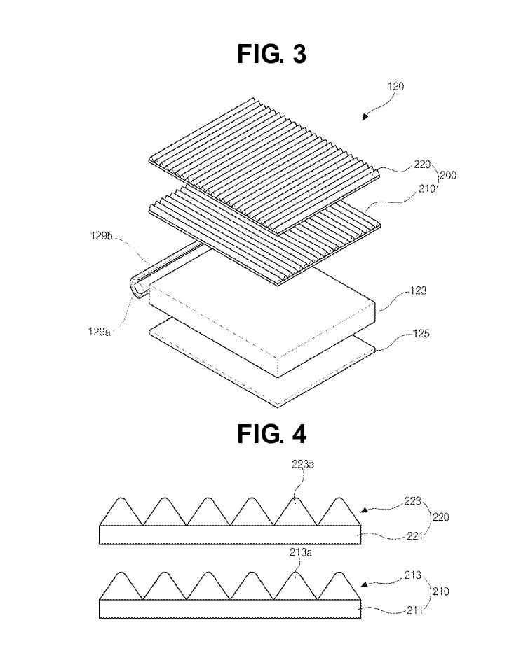

FIG. 3 is a schematic exploded perspective view of a backlight unit in FIG. 2, and FIG. 4 is a schematic cross-sectional view of a light shaping film of a backlight unit for an LCD device according to the present invention.

As shown in FIGS. 3 and 4, the backlight unit 120 includes the reflective sheet 125, the lamp 129a, the lamp guide 129b for guiding the lamp 129a, the light guide plate 123 and the light shaping film 200. The reflective sheet 125 is disposed on the bottom frame 150 (of FIG. 2) and has a color of white or silver. The lamp 129a as a light source is disposed at one length-direction edge of the reflective sheet 125. The light guide plate 123 is disposed on the reflective sheet 125, and one side of the light guide plate 123 face the lamp 129a. The light shaping film 200 is disposed on the light guide plate 123 and under the liquid crystal panel 110. A lower surface of the light shaping film 200 contacts the light guide plate 123, and an upper surface of the light shaping film 200 contacts the liquid crystal panel 110.

A side of the lamp guide 129b facing the light guide plate 123 is opened, and other portions of the lamp guide 129b covers the lamp 129a. The lamp guide 129b protects the lamp 129a and light from the lamp 129a is further concentrated to the light guide plate 123 due to the lamp guide 129b.

One of a cold cathode fluorescent lamp (CCFL) and an external electrode fluorescent lamp (EEFL) is used as the lamp 129a. Alternatively, a light emitting diode (LED) may be used as the lamp 129a. The lamp 129a of the LED does not require the lamp guide 129b.

The light guide plate 123 is formed of a transparent material, such as polymethylmethacrylate (PMMA) and polycarbonate (PC). The light guide plate 123 has a flat shape.

The reflective sheet 125 is disposed under the light guide plate 123. The light through a rear surface of the light guide plate 123 is reflected on the reflective sheet 125 toward the liquid crystal panel 110 (of FIG. 2) such that brightness is increased.

The light through the light guide plate 123 is diffused and concentrated by the light shaping film 200 on the light guide plate 123 such that an uniform plate light source is provided on the liquid crystal panel 110 (of FIG. 2). The light shaping film 200 includes first and second light shaping film 210 and 220. Each of the first and second light shaping films 210 and 220 has a haze property such that the light is dispersed and a direction of the light is controlled. The first and second light shaping films 210 and 220 respectively includes first and second light-concentrating layers 213 and 223 such that the light is concentrated toward the liquid crystal panel 110 (of FIG. 2).

In more detail, light through the light guide plate 123 is diffused and concentrated by the first and second light shaping films 210 and 220 toward the liquid crystal panel 110 (of FIG. 2). As a result, the backlight unit 120 according to the present invention has improved light efficiency with compared to the related art backlight unit including the diffusion sheet 21a (of FIG. 1), the light-concentration sheet 21b (of FIG. 1) and the protection sheet 21c (of FIG. 1).

In FIG. 4, the first light shaping film 210 includes a first base layer 211 and a first light-concentration layer 213 on the first base layer 211, and the second light shaping film 220 includes a second base layer 221 and a second light-concentration layer 223 on the second base layer 221. For example, each of the first and second base layers 211 and 221 may be formed of polymethylmethacrylate (PMMA) or Polyethyleneterphthalate (PET). For example, each of the first and second light-concentration layers 213 and 223 may be formed of transparent acryl-based resin or a photosensitive material such as photoresist. Each of the first and second light-concentration layers 213 and 223 has a prism shape. Namely, the first light shaping film 210 includes the first base layer 211 and a plurality of first prism patterns 213a on the first base layer 211. In addition, the second light shaping film 220 includes the second base layer 221 and a plurality of second prism patterns 223a on the second base layer 221. The first prism patterns 213a of the first light shaping film 210 cross the second prism patterns 223a of the second light shaping film 220. For example, the first prism patterns 213a of the first light shaping film 210 are perpendicular to the second prism patterns 223a of the second light shaping film 220.

Each of the first and second prism patterns 213a and 223a has a round-shape. For example, a vertex of each of the first and second prism patterns 213a and 223a has a radius of curvature of about 4 micrometers. Due to the first and second prism patterns 213a and 223a, the, light is diffused and concentrated by the first and second light shaping films 210 and 220 toward the liquid crystal panel 110 (of FIG. 2) on the light shaping film 200 such that brightness is increased.

Each of the first and second light-concentration layers 213 and 223 has a refractive index of about 1.55 to 1.58. Each of the first and second base layers 211 and 221 has a haze of about 15 to 55%. The haze is a phenomenon where light, which passes through a transparent material, is diffused according to a natural property of the transparent material to obscure the clarity. The haze is calculated by following equation.

Haze property (%)={(a total quantity of light)−(a quantity of direct moving light)}/(a total quantity of light)*100

Brightness of a viewing angle are controlled by the haze. When the haze is smaller than 10%, the light diffusion rate is too low such that a desired viewing angle can not be obtained. When the haze is larger than 60%, the light transmissive rate is too low such that desired brightness can not be obtained. Accordingly, when each of the first and second base layers 211 and 221 has a haze of about 15 to 55%, the desired brightness and the desired viewing angle are obtained.

To has the desired haze, each of the first and second base layers 211 and 221 may has a light-diffusion particle, for example, a bead (not shown), or a fine pattern (not shown) at their rear surface. The light is diffused by the bead such that it is prevented for the light being partially concentrated. A light-diffusion angle may be controlled by a shape of the fine pattern. For example, the fine pattern may has one of an elliptical shape and a polygonal shape. Alternatively, the fine pattern may be a hologram pattern.

The light from the lamp 129a is guided by the lamp guide 129b to pass through the light guide plate 123. The light passes through the first and second light shaping films 210 and 220 to be treated into an uniform brightness light source. As a result, the liquid crystal panel 110 (of FIG. 2) provides a high quality image.

Namely, the backlight unit 120 according to the present invention provides much uniform plane light source due to the first and second light shaping films 210 and 220 than the backlight unit according to the related art. The light shaping film 200 can replace the optical sheet 21 (of FIG. 1) such that modulation process yield for the LCD device is improved and production costs for the LCD device is reduced.

The above LCD device is explained with the side type backlight unit. Alternatively, the light shaping film 200 including the first and second light shaping films 210 and 220 may be applied to the direct type backlight unit.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a liquid crystal panel; and
a backlight unit providing a light to the liquid crystal panel, the backlight unit including:
a light source under the liquid crystal panel; and
first and second light shaping films between the light source and the liquid crystal panel, the first light shaping films including a first base layer and a plurality of first prism patterns, and the second light shaping films including a second base layer and a plurality of second prism patterns,
wherein each of the first and second base layers has a haze, and the plurality of first prism patterns cross the plurality of second prism patterns.

2. The liquid crystal display device according to claim 1, wherein the backlight unit further comprising a reflective sheet under the light source.

3. The liquid crystal display device according to claim 1, wherein the backlight unit further comprising a light guide plate on the reflective sheet and under the first and second light shaping films, wherein the light source is disposed at least one side of the light guide plate.

4. The liquid crystal display device according to claim 1, wherein each of the first and second base layers is formed of polymethylmethacrylate (PMMA) or Polyethyleneterphthalate (PET).

5. The liquid crystal display device according to claim 1, wherein each of the first and second prism patterns has a round-shape.

6. The liquid crystal display device according to claim 5, wherein a vertex of each of the first and second prism patterns has a radius of curvature of about 4 micrometers.

7. The liquid crystal display device according to claim 1, wherein each of the first and second prism patterns are formed of an acryl-based resin or a photosensitive material.

8. The liquid crystal display device according to claim 1, wherein the haze of each of the first and second base layers has a range of about 15 to 55%.

9. The liquid crystal display device according to claim 1, wherein each of the first and second base layers includes a bead or a fine pattern.

10. The liquid crystal display device according to claim 1, wherein the light source includes one of a cold cathode fluorescent lamp (CCFL), an external electrode fluorescent lamp (EEFL) and a light emitting diode (LED).

11. The liquid crystal display device according to claim 1, further comprising a main frame covering sides of the backlight unit and the liquid crystal panel, a top frame covering front edges of the liquid crystal panel, and a bottom frame covering a rear side of the backlight unit.

12. A light shaping film for a backlight unit of a liquid crystal panel, comprising:
a first film including a first base layer and a plurality of first prism patterns; and
a second film including a second base layer and a plurality of second prism patterns,
wherein each of the first and second base layers has a haze, and the plurality of first prism patterns cross the plurality of second prism patterns.

13. The light shaping film according to claim 12, wherein each of the first and second base layers is formed of polymethylmethacrylate (PMMA) or Polyethyleneterphthalate (PET).

14. The light shaping film according to claim 12, wherein each of the first and second prism patterns has a round-shape.

15. The light shaping film according to claim 14, wherein a vertex of each of the first and second prism patterns has a radius of curvature of about 4 micrometers.

16. The light shaping film according to claim 12, wherein each of the first and second prism patterns are formed of an acryl-based resin or a photosensitive material.

17. The light shaping film according to claim 12, wherein the haze of each of the first and second base layers has a range of about 15 to 55%.

18. The light shaping film according to claim 12, wherein each of the first and second base layers includes a bead or a fine pattern.
